(19) United States
(12) Patent Application Publication
(10) Pub. No.: US 2017/0240237 A1
(43) Pub. Date: Aug. 24, 2017

(54) Dual Shield Fairing Windshield System

(71) Applicant: Jim Fraley, Warr Acres, OK (US)

(72) Inventor: Jim Fraley, Warr Acres, OK (US)

(21) Appl. No.: 15/052,826

(22) Filed: Feb. 24, 2016

(51) Int. Cl. B62J 17/04; B60J 1/06

(52) U.S. Cl. CPC B62J 17/04; B60J 1/06

(57) ABSTRACT

A dual shield fairing windshield system for selective shielding of a driver and passenger includes a vehicle that has a fairing. A slot extends through a top surface of the fairing, defining a cavity under a top surface of the fairing. A first track and a second track are positioned in the cavity and aligned with the slot. A first shield is positioned in the first track such that the first shield is extendable out of the slot to an extended position. A second shield is positioned in the second track such that the second shield is extendable out of the slot to an exposed position.

### BACKGROUND OF THE DISCLOSURE

### Field of the Disclosure

The disclosure relates to windshield systems and more particularly pertains to a new windshield system for selective shielding of a driver and passenger.

### SUMMARY OF THE DISCLOSURE

An embodiment of the disclosure meets the needs presented above by generally comprising a vehicle that has a fairing. A slot extends through a top surface of the fairing, defining a cavity under a top surface of the fairing. A first track and a second track are positioned in the cavity and aligned with the slot. A first shield is positioned in the first track such that the first shield is extendable out of the slot to an extended position. A second shield is positioned in the second track such that the second shield is extendable out of the slot to an exposed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a dual shield fairing windshield system according to an embodiment of the disclosure.

FIG. 2 is a front view of an embodiment of the disclosure.

FIG. 3 is a rear view of an embodiment of the disclosure.

FIG. 4 is a cross-sectional view of an embodiment of the disclosure.

FIG. 5 is a cross-sectional view of an embodiment of the disclosure.

### DESCRIPTION OF THE PREFERRED EMBODIMENT

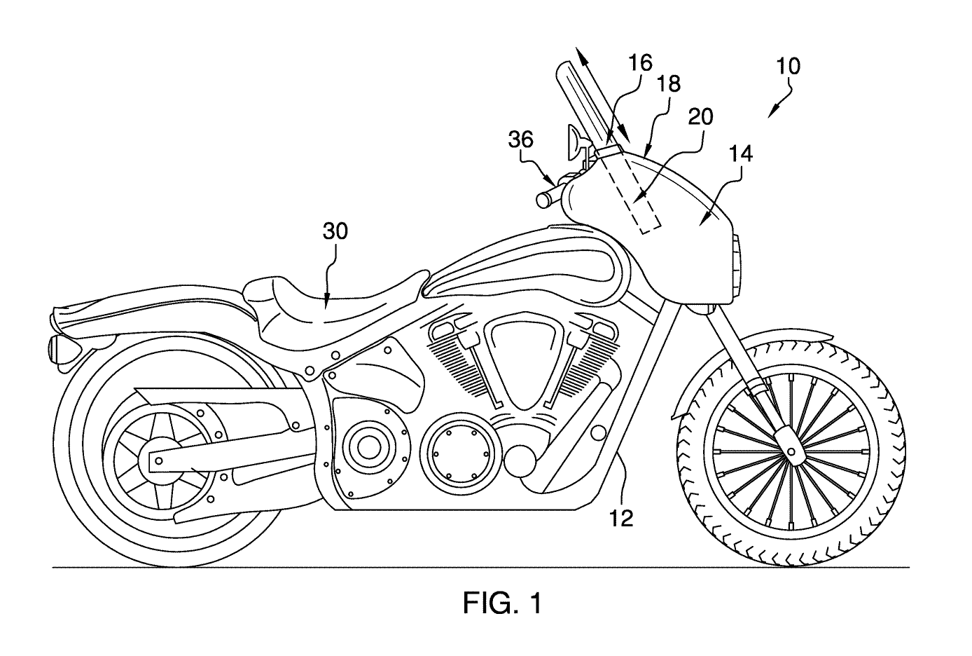

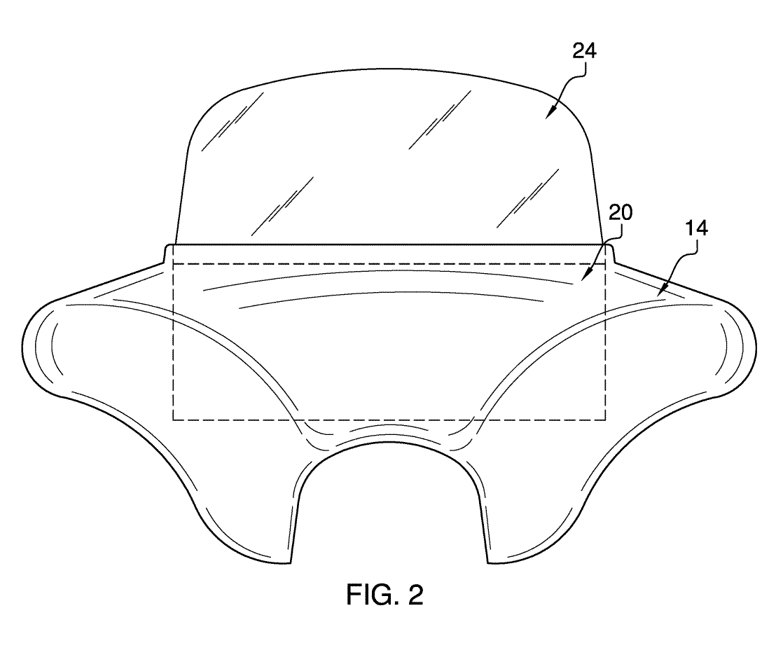

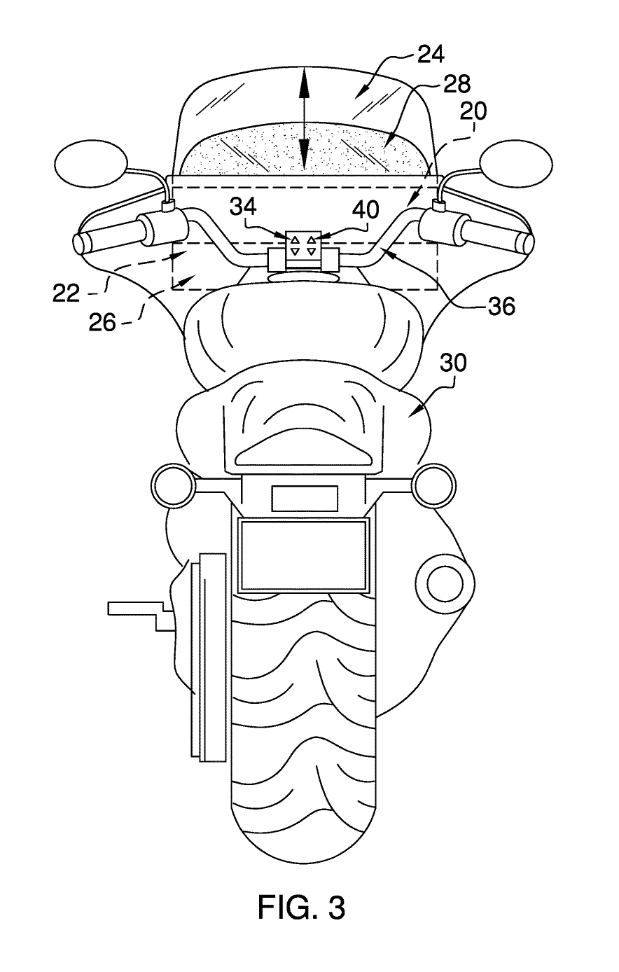

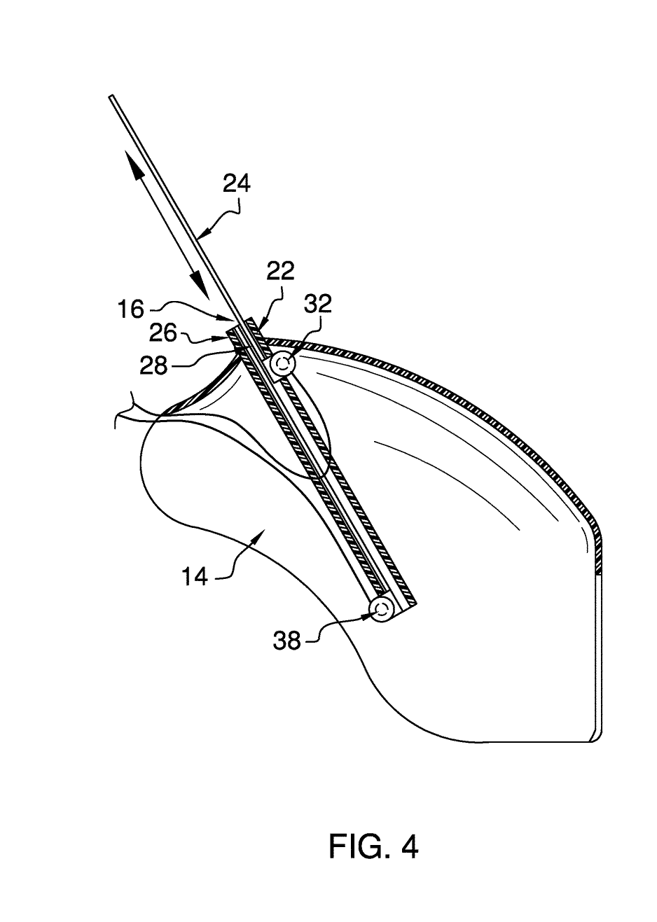

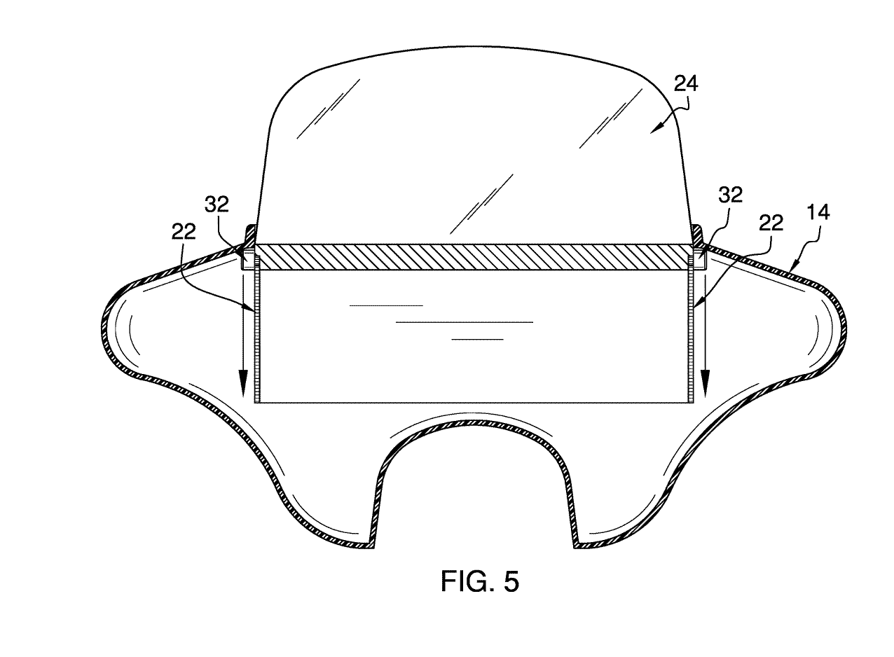

With reference now to the drawings, and in particular to FIGS. 1 through 5 thereof, a new windshield system embodying the principles and concepts of an embodiment of the disclosure and generally designated by the reference numeral 10 will be described.

As best illustrated in FIGS. 1 through 5, the dual shield fairing windshield system 10 generally comprises a vehicle 12 that has a fairing 14. A slot 16 extends through a top surface 18 of the fairing 14, defining a cavity 20 under the top surface 18 of the fairing 14. A first track 22 is positioned in the cavity 20 and is aligned with the slot 16. A first shield 24 is positioned in the first track 22. The first shield 24 is extendable out of the slot 16 to an extended position. The first shield 24 is transparent.

A second track 26 is positioned in the cavity 20. The second track 26 is aligned with the slot 16. A second shield 28 is positioned in the second track 26 and is extendable out of the slot 16 to an exposed position. The second shield 28 is clear, preferably transparent. More preferably, the second shield 28 is tinted.

The vehicle 12 has a seat 30 that is positioned rearwardly of the fairing 14. The second shield 28 is positioned between the first shield 24 and the seat 30. A first motor 32 coupled to the fairing 14. The first motor 32 is operationally coupled to the first shield 24, such that the first shield 24 is extendable from and retractable into the slot 16 by action of the first motor 32. A first motor control 34 is coupled to the vehicle 12. The first motor control 34 is operationally coupled to the first motor 32. The first motor 32 is actuated by manipulation of the first motor control 34. Preferably, the first motor control 34 is positioned on a steering mechanism 36 of the vehicle 12.

A second motor 38 is coupled to the fairing 14. The second motor 38 is operationally coupled to the second shield 28, such that the second shield 28 is extendable from and retractable into the slot 16 by action of the second motor 38. A second motor control 40 is coupled to the vehicle 12. The second motor control 40 is operationally coupled to the second motor 38. The second motor 38 is actuated by manipulation of the second motor control 40. Preferably, the second motor control 40 is positioned on the steering mechanism 36 of the vehicle 12.

Preferably, the first shield 24 and the second shield 28 are separately extendable and retractable.

In use, the seat 30 is configured for seating of the user, such that the first shield 24 and the second shield 28 are selectively positionable in front of the user. The first motor control 34 and the second motor control 40 are configured for manipulation to selectively actuate the first motor 32 and the second motor 38, respectively. Actuation of the first motor 32 motivates the first shield 24 along the first track 22 through the slot 16 to an extended position. The first motor 32 also is positioned to motivate the first shield 24 along the first track 22 into the slot 16 to a retracted position. Actuation of the second motor 38 motivates the second shield 28 along the second track 26 through the slot 16 to an exposed position. The second motor 38 also is positioned to motivate the second shield 28 along the second track 26 into the slot 16 to a retracted position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dual shield fairing windshield system comprising:
a vehicle, said vehicle having a fairing;
a slot extending through a top surface of said fairing defining a cavity under said top surface of said fairing;
a first track positioned in said cavity, said first track being aligned with said slot;
a first shield positioned in said first track wherein said first track is extendable out of said slot to an extended position such that said first shield extends out of said slot;
a second track positioned in said cavity, said second track being aligned with said slot; and
a second shield positioned in said second track wherein said second track is extendable out of said slot to an exposed position such that said second shield extends out of said slot.

2. The system of claim 1, further comprising said first shield being transparent.

3. The system of claim 2, further comprising said second shield being clear.

4. The system of claim 1, further comprising said second shield being transparent.

5. The system of claim 4, further comprising said second shield being tinted.

6. The system of claim 1, further comprising said vehicle having a seat positioned rearwardly of said fairing, said second shield being positioned between said first shield and said seat.

7. The system of claim 1, further comprising a first motor coupled to said fairing, said first motor being operationally coupled to said first shield wherein said first shield is extendable and retractable by said first motor.

8. The system of claim 7, further comprising a first motor control coupled to said vehicle having said fairing, said first motor control being operationally coupled to said first motor wherein said first motor is actuated by manipulation of said first motor control.

9. The system of claim 8, further comprising a second motor coupled to said fairing, said second motor being operationally coupled to said second shield wherein said second shield is extendable and retractable by said second motor.

10. The system of claim 9, further comprising a second motor control coupled to said vehicle having said fairing, said second motor control being operationally coupled to said second motor wherein said second motor is actuated by manipulation of said second motor control.

11. The system of claim 8, further comprising said first motor control being positioned on a steering mechanism of said vehicle having said fairing.

12. The system of claim 10, further comprising said second motor control being positioned on a steering mechanism of said vehicle having said fairing.

13. The system of claim 1, further comprising said first shield and said second shield being separately extendable and retractable.

14. A dual shield fairing windshield system comprising:
a vehicle, said vehicle having a fairing;
a slot extending through a top surface of said fairing defining a cavity under said top surface of said fairing;
a first track positioned in said cavity, said first track being aligned with said slot;
a first shield positioned in said first track wherein said first track is extendable out of said slot to an extended position such that said first shield extends out of said slot, said first shield being transparent;
a second track positioned in said cavity, said second track being aligned with said slot; and
a second shield positioned in said second track wherein said second track is extendable out of said slot to an exposed position such that said second shield extends out of said slot, said second shield being clear, said second shield being transparent, said second shield being tinted;
said vehicle having a seat positioned rearwardly of said fairing, said second shield being positioned between said first shield and said seat;
a first motor coupled to said fairing, said first motor being operationally coupled to said first shield wherein said first shield is extendable and retractable by said first motor;
a first motor control coupled to said vehicle having said fairing, said first motor control being operationally coupled to said first motor wherein said first motor is actuated by manipulation of said first motor control, said first motor control being positioned on a steering mechanism of said vehicle having said fairing;
a second motor coupled to said fairing, said second motor being operationally coupled to said second shield wherein said second shield is extendable and retractable by said second motor;
a second motor control coupled to said vehicle having said fairing, said second motor control being operationally coupled to said second motor wherein said second motor is actuated by manipulation of said second motor control, said second motor control being positioned on a steering mechanism of said vehicle having said fairing;
said first shield and said second shield being separately extendable and retractable.
